(19) United States
(12) Patent Application Publication
(10) Pub. No.: US 2026/0198517 A1
(43) Pub. Date: Jul. 16, 2026

(54) COLD BEVERAGE MAKER

(71) Applicant: Guangdong Welly Electrical Appliances Co., Ltd., Zhongshan (CN)

(72) Inventors: Xiangan Wu, Zhongshan (CN); Linjun Mai, Zhongshan (CN); Qiubo Liao, Zhongshan (CN); Wenzhan Hu, Zhongshan (CN); Yangyang Ma, Zhongshan (CN)

(21) Appl. No.: 19/079,504

(22) Filed: Mar. 14, 2025

(30) Foreign Application Priority Data
Jan. 16, 2025 (CN) 202510074287.0

(51) Int. Cl. A23G 9/22; A23G 9/28

(52) U.S. Cl. CPC A23G 9/224; A23G 9/28

(57) ABSTRACT

The present disclosure provides a cold beverage maker, including a housing assembly, a refrigeration assembly, a stirring assembly, and a feed and discharge assembly, where the stirring assembly includes a stirring driving member and a stirring member; the stirring member surrounds an evaporator; the stirring driving member is in transmission connection with the stirring member; the feed and discharge assembly includes a cartridge body; a storage space is formed between the cartridge body and the evaporator; the cartridge body is sleeved on the evaporator; the cartridge body further includes a guide portion; and an inner wall of the guide portion forms a concave surface. The present disclosure can guide the cold beverage product of small particles, facilitates backflow of the formed solid-liquid mixture, and improves stirring efficiency.

### CROSS REFERENCE TO RELATED APPLICATIONS

The present application claims the benefit of Chinese Patent Application No. 2025100742870 filed on Jan. 16, 2025, the contents of which are incorporated herein by reference in their entirety.

### TECHNICAL FIELD

The present disclosure relates to the technical field of cold beverage makers, and in particular to a cold beverage maker.

### BACKGROUND

As a common cold beverage processing device, the smoothie maker has been widely applied to cold beverage shops, restaurants, home kitchens, etc. The existing smoothie makers are generally limited to producing smoothies, a type of cold beverage characterized by large ice crystals and a coarse texture. These smoothie makers typically utilize a cartridge body to contain and store raw materials and the resulting mixture. After raw materials are poured into the cartridge body, the evaporator of the refrigeration assembly is configured to freeze the material into ice crystals gradually, and the stirring member of the stirring assembly is configured to stir the freezing material to form smoothie with distinct particles. In the stirring process, the smoothie moves continuously in the cartridge body. Since the cartridge body is internally sealed, the smoothie moving with the stirring member moves to a front end of the cartridge body gradually. Driven by an extruding force, the smoothie flows back to a rear end of the cartridge body from the front end of the cartridge body, without affecting the normal stirring operation. However, the existing smoothie maker cannot make ice cream products with smaller ice crystals and a delicate mouthfeel. The smaller particles of the ice cream products fall into small corners more easily. The front end of the cartridge body in the smoothie maker is usually a right angle or a plane. Because of no corresponding guide structure, the ice cream products with the smaller ice crystals are retained easily at the front end of the cartridge body. It is hard to achieve the normal backflow circulation, affecting the subsequent stirring efficiency.

### SUMMARY

A technical problem to be solved by the present disclosure is to provide a cold beverage maker. The present disclosure can guide the cold beverage product of small particles, facilitates backflow of the formed solid-liquid mixture, and improves stirring efficiency.

In order to solve the above technical problem, the present disclosure provides a cold beverage maker, including a housing assembly, a refrigeration assembly, a stirring assembly, and a feed and discharge assembly, where the refrigeration assembly includes an evaporator; the stirring assembly includes a stirring driving member and a stirring member; the stirring member surrounds the evaporator; and the stirring driving member is in transmission connection with the stirring member;
the feed and discharge assembly includes a cartridge body and a discharge mechanism provided at one end of the cartridge body; a feed port is formed in the cartridge body; the cartridge body is sleeved on the evaporator; a storage space is formed between the cartridge body and the evaporator; and the stirring driving member can be configured to drive the stirring member to rotate and stir in the storage space;
the cartridge body further includes a guide portion; and the guide portion is provided at an end of the cartridge body close to the discharge mechanism; and
at least a part of an outer contour for a cross section of the cartridge body is elliptical or approximately elliptical.

As an improvement to the above solution, the guide portion inclines gradually from an upper portion of the cartridge body to the discharge mechanism; and an inner wall of the guide portion forms a concave surface.

As an improvement to the above solution, a transitional connection portion is provided between an outer wall of the cartridge body and the feed port; and the transitional connection portion extends gradually from the outer wall of the cartridge body to the feed port.

As an improvement to the above solution, the transitional connection portion is an arc transition or an oblique transition or has a smooth surface.

As an improvement to the above solution, a width of the transitional connection portion is gradually increased from the outer wall of the cartridge body to the feed port.

As an improvement to the above solution, the end of the cartridge body close to the discharge mechanism is provided with a side end surface; the discharge mechanism is provided on the side end surface; an upper portion of the side end surface is connected to a lower portion of the guide portion to form a first connecting line; an upper sidewall of the cartridge body is connected to an upper portion of the guide portion to form two second connecting lines; and the two second connecting lines incline symmetrically from a top of the cartridge body to two sides of the guide portion.

As an improvement to the above solution, ends of the two second connecting lines intersect with each other, and the other ends of the two second connecting lines respectively extend to the two sides of the guide portion, and are respectively connected to two ends of the first connecting line.

As an improvement to the above solution, an end of the stirring member close to the discharge mechanism is provided with an extruding end; and a minimum distance between the extruding end and the side end surface ranges from 3 mm to 10 mm.

As an improvement to the above solution, a maximum distance between an outer edge of a spiral portion of the stirring member and an inner wall of an upper portion of the cartridge body ranges from 2 mm to 38 mm.

As an improvement to the above solution, a maximum distance between the outer edge of the spiral portion of the stirring member and an inner wall of a lower portion of the cartridge body ranges from 1.5 mm to 4 mm.

A maximum distance between the outer edge of the spiral portion of the stirring member and an inner wall of each of a left side and a right side of the cartridge body ranges from 1.5 mm to 6 mm.

As an improvement to the above solution, the cartridge body further includes a feed portion; the transitional connection portion protrudes upward from a surface of a cartridge body surface and is provided at an end of the cartridge body away from the discharge mechanism; the feed port is formed in the feed portion; the feed portion is provided on the transitional connection portion; a feed chamber is provided in the transitional connection portion; the feed chamber communicates with the storage space; and a size of a longitudinal section of the feed chamber is greater than a size of a longitudinal section of the storage space.

As an improvement to the above solution, the stirring member further includes a connection ring, a transmission piece, and a stirring strip; the connection ring is provided at an end of the stirring member close to the stirring driving member; the transmission piece is provided at an end of the stirring member close to the discharge mechanism; the stirring strip extends spirally from a circumferential direction of the connection ring to the transmission piece; and a movable end of the stirring driving member is in transmission connection with the transmission piece through the connection ring.

As an improvement to the above solution, a plurality of bumps are uniformly provided at an inner side of the stirring strip; the bump protrudes from the inner side of the stirring strip and can abut against a surface of the evaporator; and a surface of the bump is a protruding arc surface.

As an improvement to the above solution, the housing assembly further includes an upper support frame and a sealing plate; an accommodating groove is formed in the upper support frame; the sealing plate is fixed in the accommodating groove; the evaporator is fixed in the sealing plate; the sealing plate can be fixed at one end of the cartridge body to seal the cartridge body; and at least a part of the cartridge body can be fixed in the accommodating groove.

As an improvement to the above solution, a fixing groove is formed in a lower portion of the upper support frame; the fixing groove protrudes downward from a bottom surface of the upper support frame; and the stirring driving member is fixed in the fixing groove.

As an improvement to the above solution, the housing assembly further includes a front support frame and a rear support frame; a bottom portion of the front support frame is fixed on a front portion of a chassis; a bottom portion of the rear support frame is fixed on a rear portion of the chassis; an upper portion of the front support frame is fixed with a front portion of a bottom side of the upper support frame; and an upper portion of the rear support frame is fixed with a rear portion of the bottom side of the upper support frame.

As an improvement to the above solution, the refrigeration assembly further includes a compressor, a cooling fan, and a condenser; the compressor is fixed on the chassis; the cooling fan and the condenser are fixed at a rear side of the cold beverage maker; and the cooling fan is next to the compressor or the condenser.

As an improvement to the above solution, the housing assembly further includes side plates, a front plate, and a rear plate; the side plates are respectively provided at two sides of the chassis; the front plate is fixed at a front side of the chassis; and the rear plate is fixed at a rear side of the chassis.

As an improvement to the above solution, the discharge mechanism includes a discharge hopper, a handle, and a discharge valve; the discharge hopper is provided on the side end surface; a discharge port is formed in the side end surface; the discharge port can communicate with the discharge hopper; one end of the handle includes one side hinged to the discharge hopper, and the other side hinged to the discharge valve; and the handle can drive the discharge valve to rise or fall, thereby opening or closing the discharge hopper.

The present disclosure has the following beneficial effects:

The cold beverage maker provided by the present disclosure includes the refrigeration assembly, the stirring assembly, and the feed and discharge assembly. The refrigeration assembly includes the evaporator. The stirring assembly includes the stirring member. The feed and discharge assembly includes the cartridge body. The cartridge body is sleeved on the evaporator. The material such as the milk and the beverage can be poured into the cartridge body. The evaporator is configured to perform freezing and heat exchange on the material. The stirring member is configured to stir the material or a solid-liquid mixture in the freezing process. In the stirring process, the solid-liquid mixture moves to a front end of the cartridge body. In order that the solid-liquid mixture at the front end of the cartridge body flows back smoothly, the cartridge body further includes the guide portion. The guide portion can guide the solid-liquid mixture with small particles to move up to the upper portion of the cartridge body, and move obliquely to the middle of the cartridge body, thereby realizing backflow. The present disclosure improves stirring efficiency.

### BRIEF DESCRIPTION OF THE DRAWINGS

FIG. 1 is a schematic exploded view of a cold beverage maker according to the present disclosure;

FIG. 2 is a schematic exploded sectional view of a feed and discharge assembly according to the present disclosure;

FIG. 3 is a schematic structural view of a cartridge body according to the present disclosure;

FIG. 4 is a schematic structural view of a stirring member according to the present disclosure;

FIG. 5 is a partially sectional view of a cartridge body and a stirring member according to the present disclosure;

FIG. 6 is a schematic view illustrating a distance between a cartridge body and a stirring member according to the present disclosure; and

FIG. 7 is a schematic exploded view of a housing assembly and a refrigeration assembly according to the present disclosure.

### DETAILED DESCRIPTION

In order to make the objectives, technical solutions, and advantages of the present disclosure more clear, the present disclosure will be further described in detail below with reference to the accompanying drawings. It should be noted that orientation terms such as “upper”, “lower”, “left”, “right”, “front”, “rear”, “inner”, and “outer” that appear or are about to appear in the present disclosure are only based on the accompanying drawings of the present disclosure, and do not specifically limit the present disclosure.

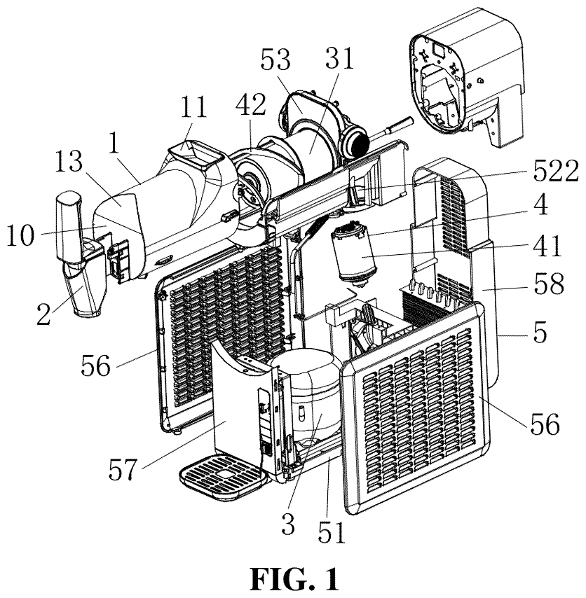

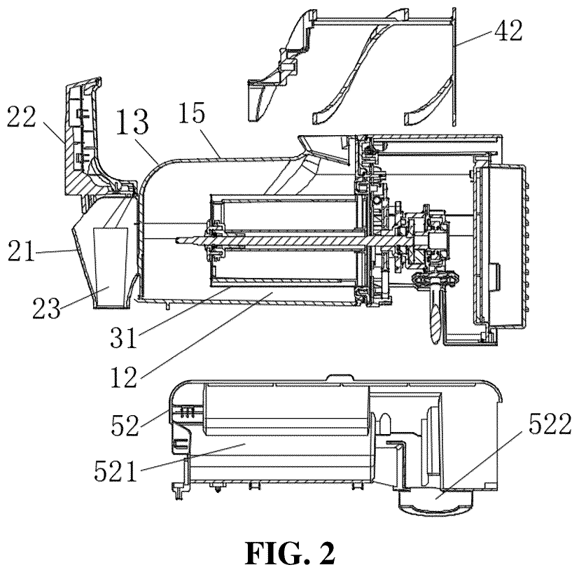

Referring to FIG. 1 and FIG. 2, an embodiment of the present disclosure provides a cold beverage maker, including a housing assembly 5, a refrigeration assembly 3, a stirring assembly 4, and a feed and discharge assembly 10. The housing assembly 5 includes a chassis 51. The chassis 51 serves as a basic support structure of the whole cold beverage maker. The refrigeration assembly 3 includes an evaporator 31. Material such as milk and beverage can exchange heat in the evaporator 31. The evaporator 31 can be configured to absorb the heat and freeze the material into ice crystals. The stirring assembly 4 includes a stirring driving member 41 and a stirring member 42. The stirring member 42 surrounds the evaporator 31, and can be configured to push and stir a solid-liquid mixture formed by the material on a surface and a periphery of the evaporator 31, such that the material forms a solid-liquid mixture with small particles. The stirring driving member 41 is in transmission connection with the stirring member 42. The stirring driving member 41 is preferably a rotary motor, a direct-current (DC) variable speed motor, etc.

The feed and discharge assembly 10 includes a cartridge body 1 and a discharge mechanism 2 provided at one end of the cartridge body 1. The cartridge body 1 can be configured to accommodate the material for making a cold beverage and the formed solid-liquid mixture. A feed port 111 is formed in the cartridge body 1. The material can be poured from the feed port 111. The cartridge body 1 is sleeved on the evaporator 31. A storage space 12 is formed between the cartridge body 1 and the evaporator 31. The material and the formed solid-liquid mixture move in the storage space 12. The stirring driving member 41 can be configured to drive the stirring member 42 to rotate and stir in the storage space 12.

In order to make the formed product flow at a front end of the cartridge body 1 conveniently, the cartridge body 1 further includes a guide portion 13. The guide portion 13 is provided at an end of the cartridge body 1 close to the discharge mechanism, namely the front end of the cartridge body 1. Under an action of the guide portion 13, the formed product can flow from a side of the discharge assembly to an upper portion of the cartridge body 1, without affecting the product flowing from a middle of the cartridge body 1 to the discharge assembly. Under a continuous extruding force, the product on the guide portion 13 can flow continuously back to the middle of the cartridge body from the upper portion of the cartridge body 1, thereby forming circulation. Considering that the ice cream with smaller particles remains in small corners easily, an inner wall of the guide portion 13 forms a concave surface. The combination of the concave surface and the cartridge body 1 is less likely to generate a dirty angle than the combination of the plane and the cartridge body 1, and is more favorable for the ice cream with the smaller ice crystals to flow smoothly. Therefore, the cold beverage maker provided by the present disclosure can be applicable to products such as smoothie and ice cream. Preferably, at least a part of an outer contour for a cross section of the cartridge body 1 is circular or elliptical or approximately elliptical. The approximately elliptical shape refers to a closed curve profile with a major axis and a minor axis, but is different from a standard ellipse in edge curvature, symmetry and the like.

The embodiments of the present disclosure have the following beneficial effects:

The cold beverage maker provided by the embodiment of present disclosure includes the refrigeration assembly 3, the stirring assembly 4, and the feed and discharge assembly 10. The refrigeration assembly 3 includes the evaporator 31. The stirring assembly 4 includes the stirring member 42. The feed and discharge assembly 10 includes the cartridge body 1. The cartridge body 1 is sleeved on the evaporator 31. The material such as the milk and the beverage can be poured into the cartridge body 1. The evaporator 31 is configured to perform freezing and heat exchange on the material. The stirring member 42 is configured to stir the material or a solid-liquid mixture in the freezing process. In the stirring process, the solid-liquid mixture moves to the front end of the cartridge body 1. In order that the solid-liquid mixture at the front end of the cartridge body 1 flows back smoothly, the cartridge body 1 further includes the guide portion 13. The guide portion 13 can guide the solid-liquid mixture with small particles to move up to the upper portion of the cartridge body 1, and move obliquely to the middle of the cartridge body 1, thereby realizing backflow. The present disclosure improves stirring efficiency.

Specifically, the guide portion 13 inclines gradually from the upper portion of the cartridge body 1 to the discharge assembly. The inner wall of the guide portion 13 forms the concave surface. The combination of the concave surface and the cartridge body 1 is less likely to generate the dirty angle than the combination of the plane and the cartridge body 1, and is more favorable for the ice cream with the smaller ice crystals to flow smoothly.

A transitional connection portion 16 is provided between an outer wall of the cartridge body 1 and the feed port 111. The transitional connection portion 16 is configured to form transitional connection between the feed port 111 and the cartridge body 1. The transitional connection portion 16 extends gradually from the outer wall of the cartridge body 1 to the feed port 111. After the material is frozen into the solid-liquid mixture, the solid-liquid mixture can be accommodated in the transitional connection portion 16, and gradually pushed from the transitional connection portion 16 to a discharge port 121 by stirring. The transitional connection portion 16 increases the accommodation volume, and can further facilitate backflow of the solid-liquid mixture from the upper portion of the cartridge body 1.

The inner wall of the guide portion 13 is a concave and continuous surface. With the concave and continuous surface, the smoothie and the ice cream can flow back smoothly to the upper portion of the cartridge body 1 from the discharge assembly. The concave and continuous surface facilitates backflow of the solid-liquid mixture, thereby forming circulation of the solid-liquid mixture in the cartridge body 1.

In some embodiments, the transitional connection portion 16 is an arc transition or an oblique transition. With the arc transition or the oblique transition, the solid-liquid mixture can move from the feed port 111 to the middle of the cartridge body 1 smoothly and gradually, and move gradually close to the discharge port 121. Further, a surface of the transitional connection portion 16 may be a smooth surface. With the smooth surface, a force of friction of the solid-liquid mixture in the transitional connection portion 16 can be reduced. This facilitates movement of the solid-liquid mixture at the transitional connection portion 16 to stir and push the material conveniently, and further reduces the stacking, retention and the like of the solid-liquid mixture at the transitional connection portion 16.

In some embodiments, a width of the transitional connection portion 16 is gradually increased from the outer wall of the cartridge body 1 to the feed port 111. In a direction away from the feed port 111, the transitional connection portion 16 forms a gradually necked channel, so as to move the solid-liquid mixture to the middle of the cartridge body 1 together.

In the embodiment of the present disclosure, the outer contour for the cross section of the cartridge body 1 is a closed contour composed of a regular smooth curve or an irregular smooth curve. With the closed contour composed of the smooth curve, the force of friction of the solid-liquid mixture on the inner wall of the cartridge body 1 can be reduced, thereby reducing the stacking, retention and the like, facilitating uniform stirring, and improving stirring efficiency.

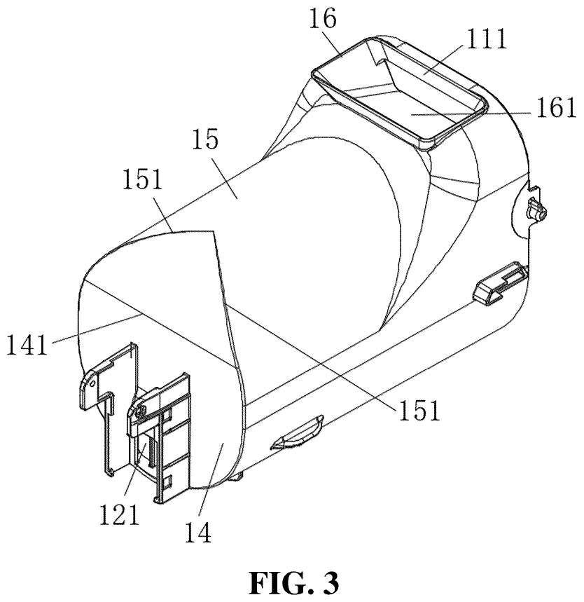

Referring to FIG. 2 and FIG. 3, the end of the cartridge body 1 close to the discharge assembly is provided with a side end surface 14. The discharge assembly is provided on the side end surface 14. The discharge port 121 is formed in the side end surface 14. The extruded solid-liquid mixture is gathered to the side end surface 14. An upper portion of the side end surface 14 is connected to a lower portion of the guide portion 13. In the embodiment, the upper portion of the side end surface 14 is tangentially connected to the lower portion of the guide portion 13. Along a junction between the side end surface 14 and the guide portion 13, the solid-liquid mixture can move smoothly from the side end surface 14 to the upper portion of the cartridge body 1. A connecting line for the side end surface 14 and the guide portion 13 is a first connecting line 141. The solid-liquid mixture is diverted for a first time at the first connecting line 141, such that the solid-liquid mixture can move from the side end surface 14 to the upper portion of the cartridge body 1.

A sidewall of the cartridge body 1 is provided with a cartridge body surface 15. The cartridge body surface 15 serves as a main sidewall of the cartridge body 1. The cartridge body surface 15 is connected to an upper portion of the guide portion 13. In the embodiment, the cartridge body surface 15 is tangentially connected to the upper portion of the guide portion 13. The solid-liquid mixture flows along the guide portion 13, and moves smoothly from the upper portion of the guide portion 13 to a connected position of the cartridge body surface 15. A connecting line for the cartridge body surface 15 and the guide portion 13 is a second connecting line 151. The solid-liquid mixture is diverted for a second time at the second connecting line 151, such that the solid-liquid mixture can flow back to the middle of the cartridge body 1, thereby forming circulation.

Referring to FIG. 3, in the embodiment of the present disclosure, there are two second connecting lines 151 that incline symmetrically from a top of the cartridge body 1 to two sides of the guide portion 13. With the two second connecting lines 151, the solid-liquid mixture can be guided from the two symmetrical sides of the guide portion 13. Meanwhile, with the inclined second connecting lines, a retention space of the solid-liquid mixture with the smaller ice crystals such as the ice cream at the guide portion 13 can be reduced, and the solid-liquid mixture flows back more smoothly.

Further, ends of the two second connecting lines 151 intersect with each other, and the other ends of the two second connecting lines respectively extend to the two sides of the guide portion 13, and are respectively connected to two ends of the first connecting line 141. Along a backflow direction of the solid-liquid mixture, the two second connecting lines 151 converge to the upper portion of the cartridge body 1 from the two ends of the first connecting line 141 and intersect. The solid-liquid mixture moving in the guide portion 13 can be gathered to a center of the upper portion of the cartridge body 1 to form a more centralized backflow route. In this way, the solid-liquid mixture flowed back has a small section overall. In case of a fixed flow rate, the flow velocity of the solid-liquid mixture in the backflow is improved, the backflow can be accelerated, and the solid-liquid mixture in a stirring state can move to the side end surface 14 smoothly, thereby ensuring backflow efficiency and stirring efficiency.

Referring to FIG. 2 and FIG. 3, the cartridge body 1 further includes a feed portion 11. The feed portion 11 is provided at an end of the cartridge body 1 away from the discharge assembly and located on the upper portion of the cartridge body 1, such that the material can be fully frozen and stirred. The feed port 111 is formed in the feed portion 11. A cross section of the feed port 111 is gradually reduced from top to bottom. The large feed port 111 is convenient to pour the material, while the necked feed port 111 is convenient to gather the material.

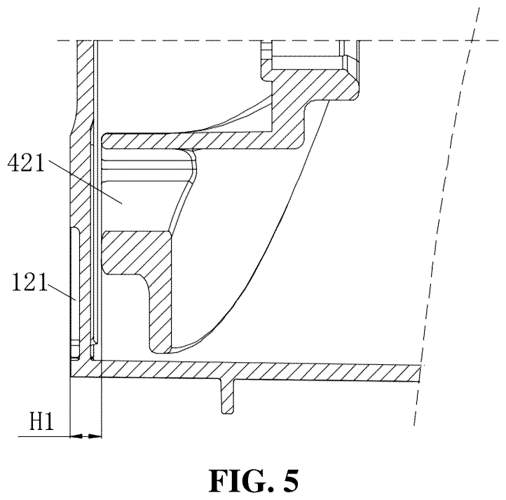

The stirring member 42 is spiral, can be configured to stir the solid-liquid mixture by means of rotation, and serves as a direct driving component for movement of the solid-liquid mixture. An end of the stirring member 42 close to the discharge assembly is provided with an extruding end 421. The extruding end 421 of the stirring member 42 is nearest to the discharge assembly. At the extruding end 421, the stirring member 42 is separated from the solid-liquid mixture. In this case, a driving force for driving the solid-liquid mixture is converted into an extruding force through which the subsequent solid-liquid mixture moves forward. Referring to FIG. 5, a minimum distance H1 between the extruding end 421 and the side end surface 14 ranges from 3 mm to 10 mm. Exemplarily, the minimum distance H1between the extruding end 421 and the side end surface 14 is 3 mm, 3.5 mm, 4 mm, 4.5 mm, 5 mm, 5.5 mm, 6 mm, 6.5 mm, 7 mm, 7.5 mm, 8 mm, 8.5 mm, 9 mm, 9.5 mm or 10 mm, but is not limited thereto. When the minimum distance between the extruding end 421 and the side end surface 14 is less than 3 mm, the solid-liquid mixture flows back hardly for the insufficient distance between the extruding end 421 and the side end surface 14 to affect a backflow effect. When the minimum distance between the extruding end 421 and the side end surface 14 is greater than 10 mm, the solid-liquid mixture flows back slowly for the excessively large distance between the extruding end 421 and the side end surface 14, and the size of the cartridge body 1 is further increased.

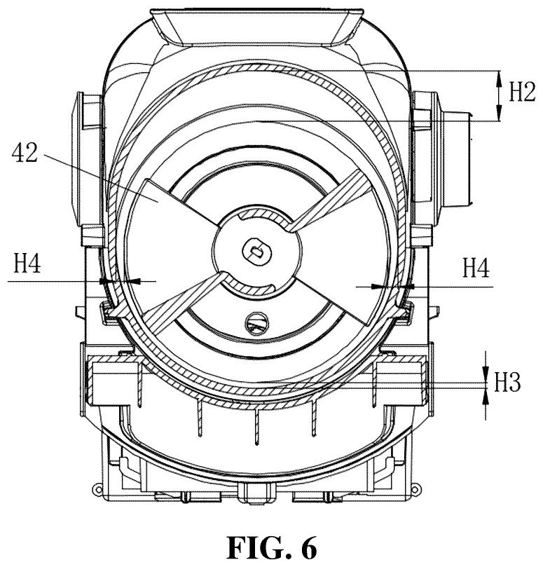

Referring to FIG. 6, a spiral portion of the stirring member 42 serves as a component for stirring the solid-liquid mixture, and is spiral overall. It can be configured to stir and push the solid-liquid mixture by means of rotation. In some embodiments, a maximum distance H2 between an outer edge of the spiral portion of the stirring member 42 and an inner wall of the upper portion of the cartridge body 1 ranges from 2 mm to 38 mm. Specifically, the maximum distance H2 between the outer edge of the spiral portion of the stirring member 42 and the inner wall of the upper portion of the cartridge body 1 is 2 mm, 2.5 mm, 3 mm, 3.5 mm, 4 mm, 4.5 mm, 5 mm, 5.5 mm, 6 mm, 6.5 mm, 7 mm, 7.5 mm, 8 mm, 8.5 mm, 9 mm, 9.5 mm, 10 mm, 10.5 mm, 11 mm, 11.5 mm, 12 mm, 12.5 mm, 13 mm, 13.5 mm, 14 mm, 14.5 mm, 15 mm, 15.5 mm, 16 mm, 16.5 mm, 17 mm, 17.5 mm, 18 mm, 18.5 mm, 19 mm, 19.5 mm, 20 mm, 20.5 mm, 21 mm, 21.5 mm, 22 mm, 22.5 mm, 23 mm, 23.5 mm, 24 mm, 24.5 mm, 25 mm, 25.5 mm, 26 mm, 26.5 mm, 27 mm, 27.5 mm, 28 mm, 28.5 mm, 29 mm, 29.5 mm, 30 mm, 30.5 mm, 31 mm, 31.5 mm, 32 mm, 32.5 mm, 33 mm, 33.5 mm, 34 mm, 34.5 mm, 35 mm, 35.5 mm, 36 mm, 36.5 mm, 37 mm, or 37.5 mm, but is not limited thereto. When the maximum distance between the outer edge of the spiral portion of the stirring member 42 and the inner wall of the upper portion of the cartridge body 1 is less than 2 mm, the volume is relatively small. A certain distance is required between the outer edge of the spiral portion of the stirring member 42 and the inner wall of the upper portion of the cartridge body 1 to reserve a largest possible accommodation space, and reserve a space for the backflow of the solid-liquid mixture. When the maximum distance between the outer edge of the spiral portion of the stirring member 42 and the inner wall of the upper portion of the cartridge body 1 is greater than 38 mm, the volume is excessively large, and the solid-liquid mixture cannot be stirred by the stirring member 42 completely to cause stacking, retention and the like.

In some embodiments, a maximum distance H3 between the outer edge of the spiral portion of the stirring member 42 and an inner wall of a lower portion of the cartridge body 1 ranges from 1.5 mm to 4 mm. Exemplarily, the maximum distance H3 between the outer edge of the spiral portion of the stirring member 3 and the inner wall of the lower portion of the cartridge body 1 is 1.5 mm, 2 mm, 2.5 mm, 3 mm, 3.5 mm or 4 mm, but is not limited thereto. When the outer edge of the spiral portion of the stirring member 42 is close to the inner wall of the lower portion of the cartridge body 1, the solid-liquid mixture remains easily on the lower portion of the cartridge body 1 for a gravitational effect. Hence, the distance between the inner wall of the cartridge body 1 and the outer edge of the spiral portion of the stirring member 42 is reduced as much as possible, such that the stirring member 42 scrapes the solid-liquid mixture on the inner wall of the lower portion of the cartridge body 1 as much as possible to prevent retention of the material. When the maximum distance between the outer edge of the spiral portion of the stirring member 42 and the inner wall of the lower portion of the cartridge body 1 is greater than 4 mm, the solid-liquid mixture on the lower portion of the cartridge body 1 cannot be stirred by the stirring member 42 completely. When the maximum distance between the outer edge of the spiral portion of the stirring member 42 and the inner wall of the lower portion of the cartridge body 1 is less than 1.5 mm, the movement of the solid-liquid mixture is affected for the excessively small distance between the stirring member 42 and the inner wall of the cartridge body 1, and the rotation of the stirring member 42 is hindered.

In some embodiments, a maximum distance H4 between the outer edge of the spiral portion of the stirring member 42 and an inner wall of each of a left side and a right side of the cartridge body 1 ranges from 1.5 mm to 6 mm. Exemplarily, the maximum distance H4 between the outer edge of the spiral portion of the stirring member 3 and the inner wall of each of the left side and the right side of the cartridge body 1 is 1.5 mm, 2 mm, 2.5 mm, 3 mm, 3.5 mm, 4 mm, 5 mm, 5.5 mm or 6 mm, but is not limited thereto. Since the solid-liquid mixture at the left side and the right side of the cartridge body 1 moves down under an action of gravity, an appropriate distance may be kept between the outer edge of the spiral portion of the stirring member 42 and the inner wall of each of the left side and the right side of the cartridge body 1 to accommodate more solid-liquid mixture. When the maximum distance between the outer edge of the spiral portion of the stirring member 42 and the inner wall of each of the left side and the right side of the cartridge body 1 is less than 1.5 mm, the movement of the solid-liquid mixture is affected for the excessively small distance between the stirring member 42 and the inner wall of the cartridge body 1, and the rotation of the stirring member 42 is hindered. When the maximum distance between the outer edge of the spiral portion of the stirring member 42 and the inner wall of each of the left side and the right side of the cartridge body 1 is greater than 6 mm, the volume is excessively large, and the solid-liquid mixture cannot be stirred by the stirring member 42 completely to cause stacking, retention and the like.

In addition, the cartridge body 1 further includes the transitional connection portion 16. The transitional connection portion 16 protrudes upward from a surface of the cartridge body surface 15. The feed portion 11 is provided on the transitional connection portion 16. Since the transitional connection portion 16 protrudes upward, the position of the feed portion 11 rises to pour the material more conveniently, and expand the material accommodating space. A feed chamber 161 is provided in the transitional connection portion 16. The feed chamber 161 communicates with the storage space 12. When the material is poured, the material enters the feed chamber 161 first, and then enters the storage space 12. A size of a longitudinal section of the feed chamber 161 is greater than a size of a longitudinal section of the storage space 12, such that the volume of the cartridge body 1 for accommodating the material and the solid-liquid mixture is increased.

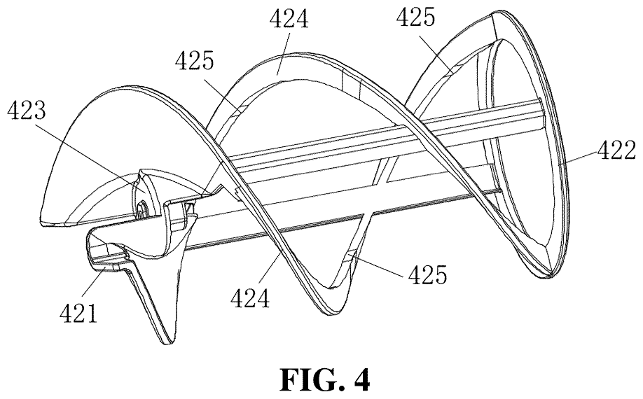

Referring to FIG. 4, the stirring member 42 includes a connection ring 422, a transmission piece 423, and a stirring strip 424. The connection ring 422 is provided at an end of the stirring member 42 close to the stirring driving member 41, and configured to fix the stirring strip 424. The transmission piece 423 is provided at an end of the stirring member 42 close to the discharge mechanism 2. The stirring strip 424 extends spirally from a circumferential direction of the connection ring 422 to the transmission piece 423. There are at least two stirring strips 424. The two stirring strips 424 surround to each other to form a plurality of spirals. The stirring strip 424 can be configured to stir the solid-liquid mixture in the storage space 12, and push the solid-liquid mixture in rotation, such that the solid-liquid mixture is gathered to the discharge mechanism 2 for discharge. A movable end of the stirring driving member 41 is in transmission connection with the transmission piece 423 through the connection ring 422.

The conventional stirring strip 424 is a simple spiral structure. For the sake of smooth slip and rotation on an outer wall of the evaporator 31, a certain gap is formed between the stirring strip 424 and the evaporator 31. However, the solid-liquid mixture on a surface of the evaporator 31 cannot be stirred for the gap, but is frozen on the surface of the evaporator 31. This cannot stir the solid-liquid mixture completely, and reduces a heat exchange capability on the surface of the evaporator 31. In view of this problem, a plurality of bumps 425 are uniformly provided at an inner side of the stirring strip 424 in the embodiment of the present disclosure. The bump 425 protrudes from the inner side of the stirring strip 424 and can abut against a surface of the evaporator 31. In rotation of the stirring strip 424, the bump 425 can slide over the surface of the evaporator 31 to damage an ice chunk on the surface of the evaporator 31, such that the ice chunk falls off and is stirred with the solid-liquid mixture. This not only stirs the solid-liquid mixture completely, but also ensures the heat exchange capability on the surface of the evaporator 31. Further, a surface of the bump 425 is a protruding arc surface. With the arc surface, a contact area between the bump 425 and the surface of the evaporator 31 can be reduced. This reduces a force of friction between the stirring strip 424 and the surface of the evaporator 31, and can increase a pressure of the bump 425 to the ice chunk on the surface of the evaporator 31 to damage the ice chunk.

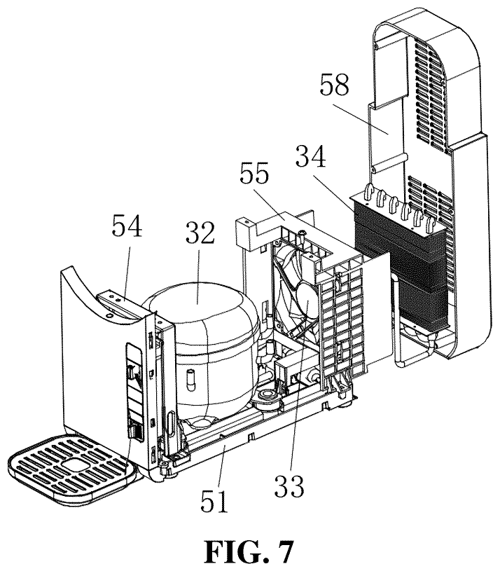

Referring to FIG. 1 and FIG. 7, in order to fix the feed and discharge assembly 10 and the evaporator 31, the housing assembly 5 further includes an upper support frame 52 and a sealing plate 53. An accommodating groove 521 is formed in the upper support frame 52. A notch of the accommodating groove 521 is upward. The sealing plate 53 is fixed in the accommodating groove 521. The sealing plate 53 is provided vertically. The evaporator 31 is fixed horizontally in the sealing plate 53. The sealing plate 53 can be fixed at one end of the cartridge body 1 to seal the cartridge body 1. After the cartridge body 1 is sleeved on the evaporator 31, the sealing plate 53 can form a sealing structure for the cartridge body 1. At least a part of the cartridge body 1 can be fixed in the accommodating groove 521 after sleeved on the evaporator.

In addition, a fixing groove 522 is formed in a lower portion of the upper support frame 52. The fixing groove 522 protrudes downward from a bottom surface of the upper support frame 52. The stirring driving member 41 is fixed in the fixing groove 522. By providing the stirring driving member 41 on the lower portion of the upper support frame 52, not only is the space at the rear side of the upper support frame 52 saved to reduce the whole size of the cold beverage maker, but also the extra space in the housing assembly 5 is used to improve the space utilization.

In order to fix the upper support frame 52, the housing assembly 5 further includes a front support frame 54 and a rear support frame 55. A bottom portion of the front support frame 54 is fixed on a front portion of a chassis 51. A bottom portion of the rear support frame 55 is fixed on a rear portion of the chassis 51. An upper portion of the front support frame 54 is fixed with a front portion of a bottom side of the upper support frame 52. An upper portion of the rear support frame 55 is fixed with a rear portion of the bottom side of the upper support frame 52, thereby fixing the upper support frame 52. The front support frame 54 and the rear support frame 55 are used to fix the upper support frame 52, which can facilitate detachment, and subsequent maintenance.

The refrigeration assembly 3 further includes a compressor 32, a cooling fan 33, and a condenser 34. The compressor 32 is fixed on the chassis 51. The cooling fan 33 and the condenser 34 are fixed at a rear side of the rear support frame 55, namely a rear side of the cold beverage maker. The cooling fan 33 is next to the compressor 32 or the condenser 34. The cooling fan 33 can dissipate heat of the compressor 32 and the condenser 34, and can ensure stable operation of the compressor 32 and the condenser 34.

In addition, the housing assembly 5 further includes side plates 56, a front plate 57, and a rear plate 58. The side plates 56 are respectively provided at two sides of the chassis 51. The front plate 57 is fixed at a front side of the chassis 51. The rear plate 58 is fixed at a rear side of the chassis 51. The side plates 56, the front plate 57 and the rear plate 58 enclose the compressor 32, the cooling fan 33 and the condenser 34.

In the discharge mechanism 2, the discharge mechanism 2 includes a discharge hopper 21, a handle 22, and a discharge valve 23. The discharge hopper 21 is provided on the side end surface 14. The discharge port 121 is formed in the side end surface 14. The discharge port 121 can communicate with the discharge hopper 21. One end of the handle 22 includes one side hinged to the discharge hopper 21, and the other side hinged to the discharge valve 23. The handle 22 can swing relative to the discharge hopper 21. In the swinging process of the handle 22, the handle 22 can drive the discharge valve 23 to rise or fall, thereby opening or closing the discharge hopper 21.

The above descriptions are merely preferred implementations of the present disclosure. It should be noted that a person of ordinary skill in the art may further make several improvements and modifications without departing from the principle of the present disclosure, but such improvements and modifications should be deemed as falling within the protection scope of the present disclosure.

1. A cold beverage maker, comprising a housing assembly, a refrigeration assembly, a stirring assembly, and a feed and discharge assembly, wherein the refrigeration assembly comprises an evaporator; the stirring assembly comprises a stirring driving member and a stirring member; the stirring member surrounds the evaporator; and the stirring driving member is in transmission connection with the stirring member;
the feed and discharge assembly comprises a cartridge body and a discharge mechanism provided at one end of the cartridge body; the cartridge body is sleeved on the evaporator; a feed port is formed in the cartridge body; a storage space is formed between the cartridge body and the evaporator; and the stirring driving member is configured to drive the stirring member to rotate and stir in the storage space;
the cartridge body further comprises a guide portion; and the guide portion is provided at an end of the cartridge body close to the discharge mechanism; and
at least a part of an outer contour for a cross section of the cartridge body is elliptical or approximately elliptical.

2. The cold beverage maker according to claim 1, wherein the guide portion inclines gradually from an upper portion of the cartridge body to the discharge mechanism; and an inner wall of the guide portion forms a concave surface.

3. The cold beverage maker according to claim 1, wherein a transitional connection portion is provided between an outer wall of the cartridge body and the feed port; the transitional connection portion extends gradually from the outer wall of the cartridge body to the feed port; and the transitional connection portion is an arc transition or an oblique transition or has a smooth surface.

4. The cold beverage maker according to claim 3, wherein a width of the transitional connection portion is gradually increased from the outer wall of the cartridge body to the feed port.

5. The cold beverage maker according to claim 1, wherein the end of the cartridge body close to the discharge mechanism is provided with a side end surface; the discharge mechanism is provided on the side end surface; an upper portion of the side end surface is connected to a lower portion of the guide portion to form a first connecting line; an upper sidewall of the cartridge body is connected to an upper portion of the guide portion to form two second connecting lines; and the two second connecting lines incline symmetrically from a top of the cartridge body to two sides of the guide portion.

6. The cold beverage maker according to claim 5, wherein ends of the two second connecting lines intersect with each other, and the other ends of the two second connecting lines respectively extend to the two sides of the guide portion, and are respectively connected to two ends of the first connecting line.

7. The cold beverage maker according to claim 1, wherein an end of the stirring member close to the discharge mechanism is provided with an extruding end; and a minimum distance between the extruding end and the side end surface ranges from 3 mm to 10 mm;
a maximum distance between an outer edge of a spiral portion of the stirring member and an inner wall of an upper portion of the cartridge body ranges from 2 mm to 38 mm;
a maximum distance between the outer edge of the spiral portion of the stirring member and an inner wall of a lower portion of the cartridge body ranges from 1.5mm to 4 mm; and
a maximum distance between the outer edge of the spiral portion of the stirring member and an inner wall of each of a left side and a right side of the cartridge body ranges from 1.5 mm to 6 mm.

8. The cold beverage maker according to claim 1, wherein the cartridge body further comprises a feed portion; the transitional connection portion protrudes upward from a surface of a cartridge body and is provided at an end of the cartridge body away from the discharge mechanism; the feed port is formed in the feed portion; the feed portion is provided on the transitional connection portion; a feed chamber is provided in the transitional connection portion; the feed chamber communicates with the storage space; and a size of a longitudinal section of the feed chamber is greater than a size of a longitudinal section of the storage space.

9. The cold beverage maker according to claim 7, wherein the stirring member further comprises a connection ring, a transmission piece, and a stirring strip; the connection ring is provided at an end of the stirring member close to the stirring driving member; the transmission piece is provided at an end of the stirring member close to the discharge mechanism; the stirring strip extends spirally from a circumferential direction of the connection ring to the transmission piece; and a movable end of the stirring driving member is in transmission connection with the transmission piece through the connection ring.

10. The cold beverage maker according to claim 9, wherein a plurality of bumps are uniformly provided at an inner side of the stirring strip; the bump protrudes from the inner side of the stirring strip and abuts against a surface of the evaporator; and a surface of the bump is a protruding arc surface.

11. The cold beverage maker according to claim 1, wherein the housing assembly comprises an upper support frame and a sealing plate; an accommodating groove is formed in the upper support frame; the sealing plate is fixed in the accommodating groove; the evaporator is fixed in the sealing plate; the sealing plate is fixed at one end of the cartridge body to seal the cartridge body; at least a part of the cartridge body is fixed in the accommodating groove; a fixing groove is formed in a lower portion of the upper support frame; the fixing groove protrudes downward from a bottom surface of the upper support frame; and the stirring driving member is fixed in the fixing groove.

12. The cold beverage maker according to claim 11, wherein the housing assembly further comprises a chassis, a front support frame and a rear support frame; a bottom portion of the front support frame is fixed on a front portion of the chassis; a bottom portion of the rear support frame is fixed on a rear portion of the chassis; an upper portion of the front support frame is fixed with a front portion of a bottom side of the upper support frame; and an upper portion of the rear support frame is fixed with a rear portion of the bottom side of the upper support frame.

13. The cold beverage maker according to claim 1, wherein the refrigeration assembly further comprises a compressor, a cooling fan, and a condenser; the compressor is fixed on the chassis; the cooling fan and the condenser are fixed at a rear side of the cold beverage maker; and the cooling fan is next to the compressor or the condenser.

14. The cold beverage maker according to claim 13, wherein the housing assembly further comprises side plates, a front plate, and a rear plate; the side plates are respectively provided at two sides of the chassis; the front plate is fixed at a front side of the chassis; and the rear plate is fixed at a rear side of the chassis.

15. The cold beverage maker according to claim 5, wherein the discharge mechanism comprises a discharge hopper, a handle, and a discharge valve; the discharge hopper is provided on the side end surface; a discharge port is formed in the side end surface; the discharge port communicates with the discharge hopper; one end of the handle comprises one side hinged to the discharge hopper, and the other side hinged to the discharge valve; and the handle is capable of driving the discharge valve to rise or fall, thereby opening or closing the discharge hopper.
